(19) United States
(12) Patent Application Publication
(10) Pub. No.: US 2004/0151147 A1
(43) Pub. Date: Aug. 5, 2004

(54) Processing wireless packets to reduce roaming host power consumption

(76) Inventor: Jeffrey L. Huckins, Chandler, AZ (US)

Correspondence Address: Timothy N. Trop, TROP, PRUNER & HU, P.C., 8554 KATY FWY, STE 100, HOUSTON, TX, 77024-1841, US

(21) Appl. No.: 10/355,508

(22) Filed: Jan. 31, 2003

(51) Int. Cl. H04Q 7/24

(52) U.S. Cl. 370/338; 370/349

(57) ABSTRACT

An access point in a wireless network may receive packets over a wired network. The access point may be provided with instructions from the host to enable an assist capability whereby the access point determines when to awaken the host from a reduced power consumption state in response to the receipt of a packet. When the station roams from a first basic service set using a first access point to a second basic service set using a second access point, information may be exchanged between those access points to enable the second access point to automatically implement the access point assist capability formerly provided by the first access point.

### BACKGROUND

This invention relates generally to wireless computer networks.

A host processor-based system may communicate with a variety of other devices to form a wireless network. A variety of peripherals and computer systems may be linked together through a wireless network. One protocol for establishing wireless links of this type is the IEEE Std. 802.11 (1999). In such a system, a host may receive packets over the network.

In some cases, the host may be a power consumption sensitive device. One example of such a device is a portable processor-based system that operates from a battery power source. To conserve power, the portable device may power down to a reduced power consumption state.

In the course of network operations, a large number of packets may be passed between various devices on the network. Some of these packets may be important and others may be less important. However, each time a packet is transmitted across the network to a given host, that host must receive the packet and determine whether the packet needs handling. If the host is in a reduced power consumption state this means that the host must transition from the reduced power consumption state to an increased power consumption state in order to handle the packet. Such transitions generally increase the power consumption of the host processor-based system.

Thus, there is a need for ways to reduce the power consumption of devices on wireless networks and particularly there is a need for ways to reduce the unnecessary interruptions of the host in reduced power consumption states.

### BRIEF DESCRIPTION OF THE DRAWINGS

FIG. 1 is a schematic depiction of a wireless network in accordance with one embodiment of the present invention;

FIG. 2 is a depiction of a host in accordance with one embodiment of the present invention;

FIG. 3 is a chart that depicts the operation of one embodiment of the present invention;

FIG. 4 is a flow chart for software for the host shown in FIG. 2 in accordance with one embodiment of the present invention;

FIG. 5 is a flow chart for software for the station shown in FIG. 2 in accordance with one embodiment of the present invention;

FIG. 6 is a flow chart for software for an access point shown in FIG. 2, in accordance with one embodiment of the present invention;

FIG. 7 is a schematic depiction of one embodiment of the present invention; and

FIG. 8 is a flow chart in accordance with one embodiment of the present invention.

### DETAILED DESCRIPTION

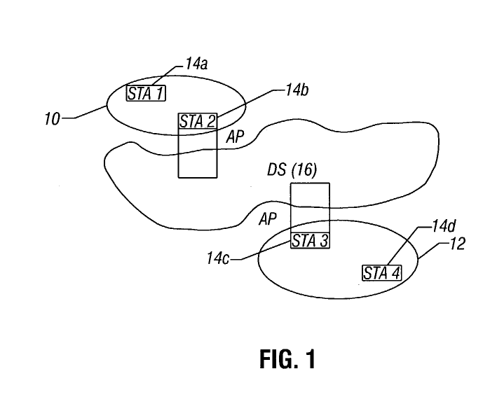

Referring to FIG. 1, a wireless network may include a plurality of basic service sets (BSS) 10 and 12 coupled through a distribution system (DS) 16. The distribution system 16 interconnects the basic service sets 10, 12 in integrated local area networks to create an extended service set. An extended service set is a set of one or more interconnected basic service sets and integrated local area networks that appears as a single basic service set to the logical link control layer at any station associated with one of those basic service sets.

Each basic service set 10 or 12 includes a set of stations (STAS) 14 controlled by a single coordination function. A coordination function is a logical function that determines when a station 14, operating within a basic service set 10 or 12, is permitted to transmit and may be able to receive protocol data units via a wireless medium.

The basic service sets 10 and 12 communicate with the distribution system 16 through access points provided by the stations 14b and 14c. An access point is any entity that has a station functionality while providing access to the distribution services via the wireless medium for associated stations. A station is a device that contains a medium access control (MAC) and a physical layer (PHY) interface to a wireless medium.

In accordance with one embodiment of the present invention, the system shown in FIG. 1 may operate in accordance with the IEEE 802.11 protocol which is set forth in IEEE Std. 802.11, 1999 Edition, available from the IEEE Standards Board, Piscataway, N.J. 08855.

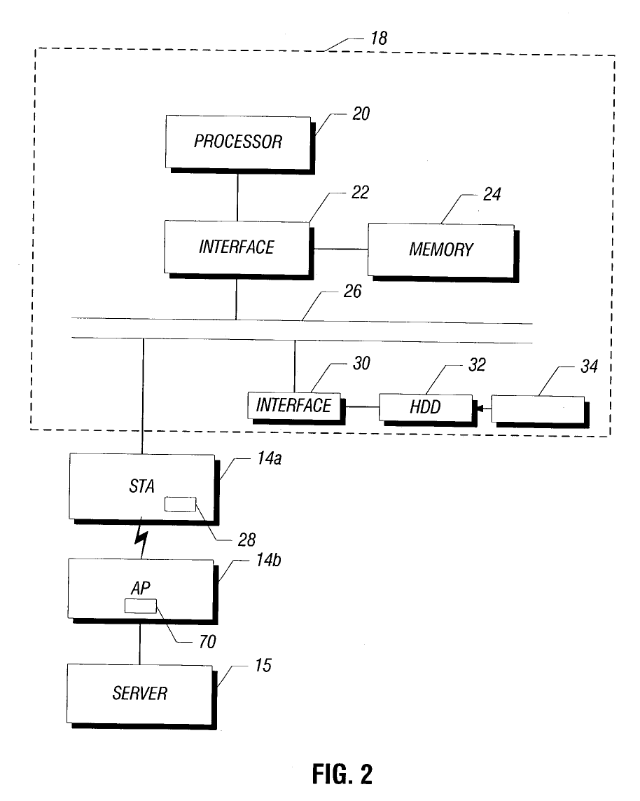

Referring to FIG. 2, the station 14a may communicate with the station 14b that acts as an access point (AP). The station 14a may be associated with a host 18 that in some embodiments may be a processor-based system including a processor 20, an interface 22 and a memory 24. The interface 22, in some embodiments, may be coupled to a bus 26 that receives the station 14a. For example, in one embodiment, the station 14a may be a network interface card (NIC) that is plugged into the bus 26. In another embodiment the station 14a is an access point as well.

The bus 26 may also support an interface 30 that is coupled to a hard disk drive 32. The drive 32 may in turn store a software program 34.

The access point 14b may be coupled over a wired network to a server 15 in one embodiment. The access point may store software 70 and may be a processor-based system in one embodiment. The station 14a may be a processor-based system and may store the software 28 in one embodiment of the present invention.

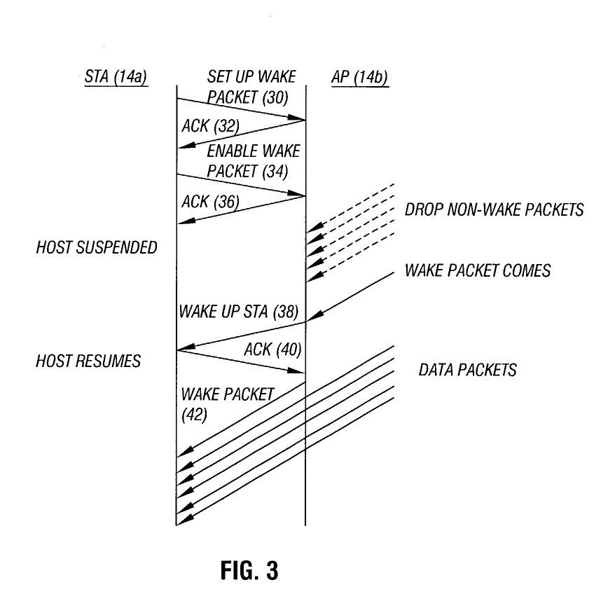

Referring to FIG. 3, wireless communications may occur between the access point 14b and the station 14a in response to information conveyed over a wired network from the server 15. In some embodiments, the host 18 may be a portable processor-based system or other power sensitive system. Thus, in some cases, the host 18 may enter reduced power consumption modes wherein its processing capabilities may be reduced. However in such modes, the power consumption of the host 18 may also be reduced.

When the host 18 is in the reduced power consumption state, it may be unnecessarily awakened from that state by the receipt of relatively unimportant packets sent, for example, by the server 15. Each time such a packet 15 arrives, absent appropriate filtering, the host 18 may be awakened, causing the host 18 to transition to a higher power consumption state. Such transitions may effectively increase the power consumption of the host 18. In battery powered applications, this reduces the useful life between battery charges of the host 18, reducing its desirability and performance.

As shown in FIG. 3, a wake packet filtering protocol, implemented on the access point 14b, filters unnecessary packets that would unnecessarily awaken the host 18, causing the host 18 to transition unnecessarily to an increased power consumption state. An access point assist capability allows a station to request an associated access point to perform wake packet processing on the station's behalf.

Initially, the station 14a sends a setup wake packet 30 to the access point 14b. The access point 14b provides an acknowledgment (ACK) 32 to the station 14a. The setup wake packet 30 provides the information needed by the access point 14b to determine which packets are of sufficient importance to involve the host 18. Thus, a filtering protocol may be provided from the station 14a to the access point 14b to enable the access point 14b to determine, while the host 18 is in a sleep or reduced power consumption mode, whether to awaken the host 18 in order to process an incoming packet. This information may be received by the station 14a from the host 18 and particularly the processor 20. The station 14a may then enable the wake packet filtering function on the access point 14b as indicated at 34, and this enable message may be acknowledged as indicated at 36.

Once the host 18 goes into a reduced power consumption mode (“Host Suspended”), any packets (“Non-Wake Packets”) that arrive at the access point 14b from the server 15 that do not meet the criteria provided by the host 18 for awakening the host 18 are simply dropped in one embodiment. When a wake packet arrives (“Wake Packet Comes”) the station is awakened as indicated at 38. A wake packet is a packet that meets the criteria provided by the host 18 for awakening the host when the host is in a reduced power consumption mode. In response to the wake up call from the access point 14b, a host 18 is awakened by the station 14a. The station 14a acknowledges the wake up call as indicated at 40. The host 18 then receives the data packets included with the communication from the server 15 as indicated at 42.

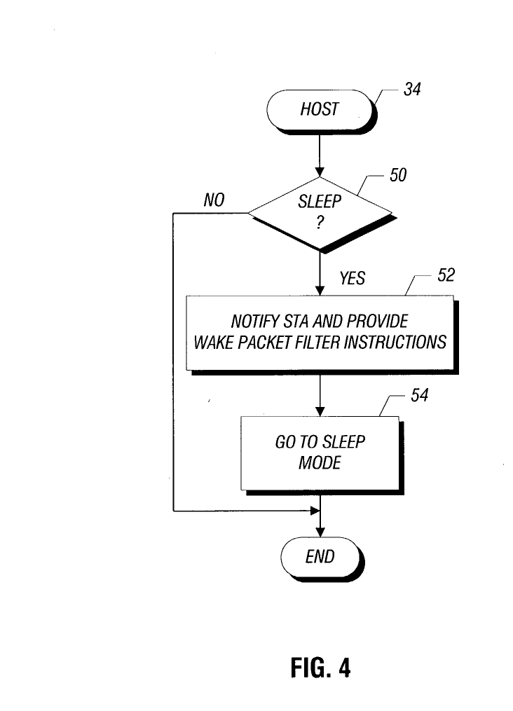

Referring to FIG. 4, in one embodiment, the software 34 stored on the host 18 initially determines whether the host desires to go into a sleep or reduced power consumption mode as indicated at diamond 50. If so, the host 18 notifies the station 14 and provides the appropriate wake packet filter instructions as indicated in block 52 to enable the access point to implement the assist capability. The host 34 then goes to the sleep mode as indicated in block 54.

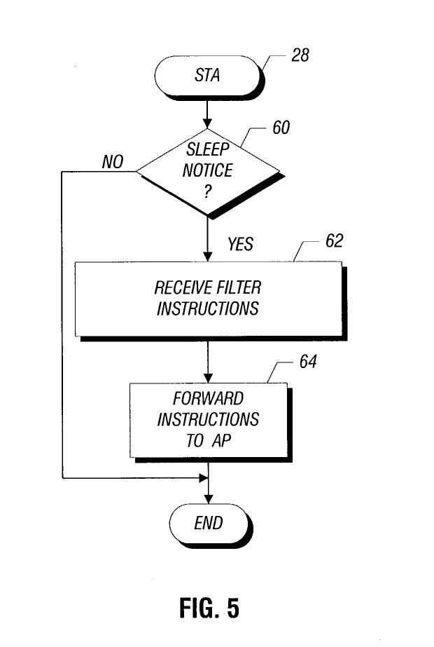

Referring to FIG. 5, in one embodiment, the station software 28 initially determines whether a notice has been received from the host 18 that the host intends to enter a reduced power consumption mode, as determined in diamond 60. If so, the station receives the wake packet filtering instructions as indicated in block 62. The station then forwards those instructions to the access point as indicated in block 64.

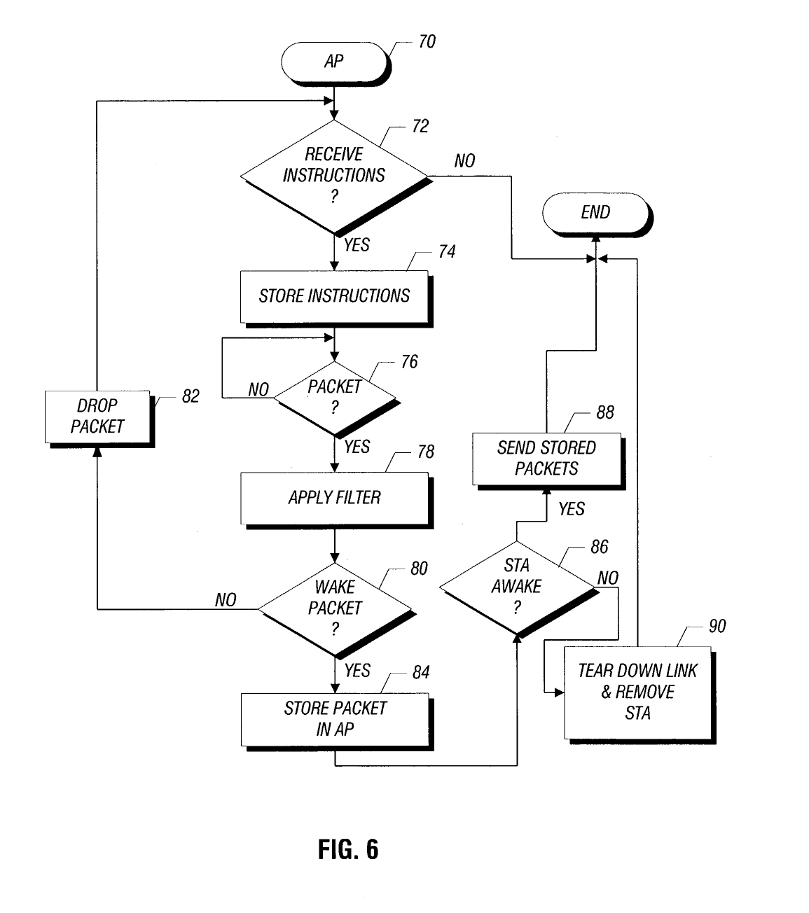

Turning finally to FIG. 6, the access point software 70, in accordance with one embodiment of the present invention, determines whether it has received wake packet filtering instructions as indicated in diamond 72. If not, after a time out, the flow ends. If the instructions have been received, those instructions may be stored as indicated in block 74. When a packet arrives at the access point, for example over the network from the server 15, the filtering instructions are applied, as indicated in block 78.

A check at diamond 80 determines whether the packet is a wake packet meaning that it is a packet which necessitates reviving the host 18. If not, in some embodiments, the packet may simply be dropped as indicated in block 82.

If the packet is a wake packet, the packet is stored in the access point 14b temporarily as indicated in block 84 in one embodiment. A check at diamond 86 determines whether the station 14a has been awakened. If so, the stored packet is sent to the station 14a which in turn transfers the packet or packets to the host 18. If the station cannot be awakened, for example, after a suitable time out period as determined in diamond 86, communication has apparently been lost between the access point and the station. Therefore, the corresponding link is torn down and the station is removed from the list of active stations with which the access point communicates, as indicated in block 90.

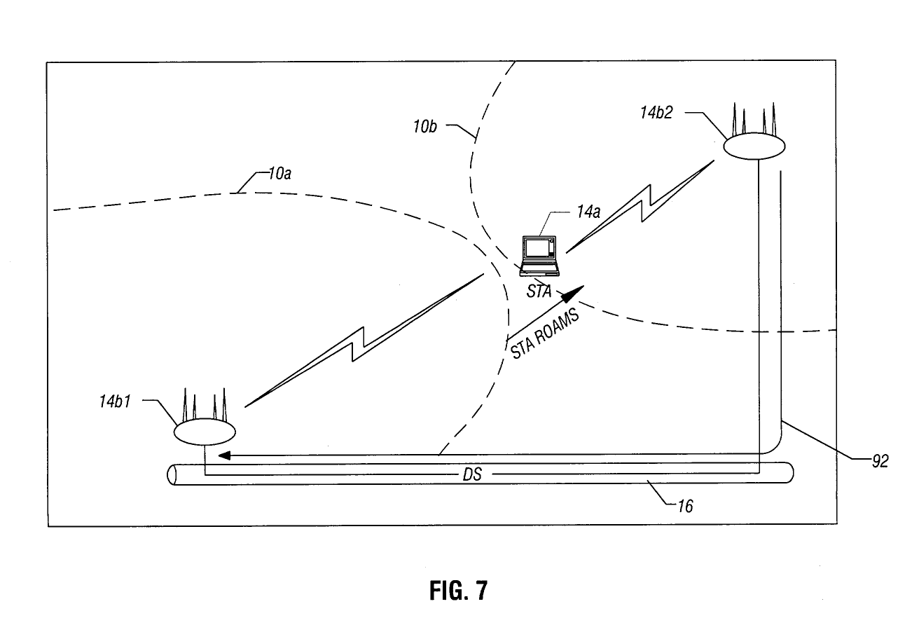

Referring to FIG. 7, a station 14a may move from the BSS 10a associated with an access point 14b1 to a BSS 10b associated with an access point 14b2. The movement from one region to another is generally referred to as roaming. In accordance with one embodiment of the present invention, when the station 14a roams from regions that use different access points, the access point assist function performed by the previous access point 14b1 may be automatically transferred to the access point 14b2. As a result, in some embodiments, a seamless continuation of the access point assist capability may be automatically implemented.

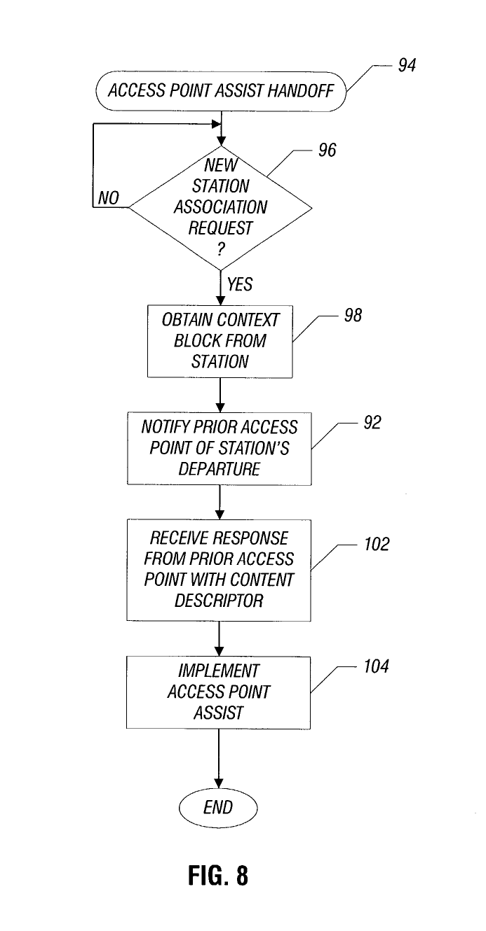

Referring to FIG. 8, the access point assist handoff software 94 begins by determining whether a new station 14 has made an association request to an access point, such as the access point 14b2, as indicated at diamond 96. If so, a context block is obtained from the station 14b as indicated in block 98. The context block may include information sufficient to enable the new access point 14b2 to contact the previous access point 14b1, for example over the DS 16 using Internet protocol addressing. Alternatively, the context block may merely identify the station.

For example, in one embodiment, the new access point 14b2 may notify the prior access point 14bl of the station 14a's departure as indicated in block 92 and as indicated by the message 92 in FIG. 7. In one embodiment, this notification may simply indicate the identity of the roaming station and may be broadcast to all the access points that are in-range. The broadcast may also include the address of the broadcasting access point. The broadcast may be made as an Internet Protocol message over the DS 16 in one embodiment.

The access point that previously was responsible for the station 14a, in this case the access point 14b1, provides a response to this message to the access point 14b2 as indicated in block 102. The response may be provided over the DS 16, in one embodiment, as an Internet Protocol message.

The response may include a content descriptor. The content descriptor provides sufficient information to enable the access point 14b2 to provide the same access point assist that was previously provided by the access point 14b1.

The new access point 14b2 may then automatically implement access point assist, as indicated in block 104, using the content descriptor to extract the needed access assist details, including the wake filtering instructions. For example, it is not necessary for new wake filtering instructions to be transferred by the station 14a to the access point 14b2 because all of this information can be obtained from the content descriptor.

Without a mechanism to handoff the access point assist responsibilities from access point to access point, a station would be required to waste cycles re-establishing the access point assist responsibilities at the new access point. Additionally, without a roaming notification being provided, the originating access point 14b1 would continue to maintain resources for the station up to the maximum keep alive time-out provided for by the applicable specifications.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
enabling a first access point to detect an in range station; and
providing the first access point with wake packet filtering instructions for the station from a second access point.

2. The method of claim 1 including enabling an access point to receive a request for association from an in-range station.

3. The method of claim 1 including broadcasting from the first access point a notification that the station has come in-range of said first access point.

4. The method of claim 1 including notifying the second access point that the station has come in-range of the first access point.

5. The method of claim 4 including receiving from the second access point information about wake packet filtering instructions for the station from the second access point.

6. The method of claim 5 including receiving those instructions over a distribution system.

7. The method of claim 5 including receiving said instructions in an Internet Protocol message.

8. An article comprising a medium storing instructions that, if executed, enable a processor-based system to:
detect an in-range station; and
receive wake packet filtering instructions for the station from another access point.

9. The article of claim 8 further storing instructions that enable the processor-based system to receive a request for association from an in-range station.

10. The article of claim 8 further storing instructions that enable the processor-based system to broadcast a notification that the station has come in-range of the first access point.

11. The article of claim 8 further storing instructions that enable the processor-based system to notify the second access point that the station has come in-range of the first access point.

12. The article of claim 11 further storing instructions that enable the processor-based system to receive, from the second access point, information about wake packet filtering instructions for the station from the second access point.

13. The article of claim 12 further storing instructions that enable the processor-based system to receive the filtering instructions over a distribution system.

14. The article of claim 13 further storing instructions that enable the processor-based system to receive said instructions as an Internet Protocol message.

15. An access point comprising:
a processor; and
a storage, coupled to said processor, storing instructions that, if executed, enable the processor to detect an in-range station and to receive wake packet filtering instructions for the station from another access point.

16. The access point of claim 15 wherein said storage stores instructions that enable the access point to receive a request for association from an in-range station.

17. The access point of claim 15 wherein said storage stores instructions that enable the access point to broadcast a notification that the station has come in-range.

18. The access point of claim 17 wherein said storage stores instructions that enable the access point to receive information about wake packet filtering instructions for the station from another access point.

19. The access point of claim 15 wherein said storage stores instructions that enable the access point to send Internet Protocol messages to other access points.

20. The access point of claim 15 wherein said storage stores instructions that enable an access point to receive information from a station to enable the access point to advise other access points of the station's identity.
